(19) United States
(12) Patent Application Publication
(10) Pub. No.: US 2006/0023126 A1
(43) Pub. Date: Feb. 2, 2006

(54) Electrophoretic display panel

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/519,054

(22) PCT Filed: Jun. 19, 2003
(86) PCT No.: PCT/IB03/02857

§ 371 Date: Dec. 22, 2004

(30) Foreign Application Priority Data
Jul. 1, 2002 (EP) 02077610.0

(51) Int. Cl. G02F 1/13

(52) U.S. Cl. 349/1

(57) ABSTRACT

An electrophoretic display panel (1), for displaying pictures having a plurality of picture elements, has a plurality of pixels (2) and drive means (100). The pixels (2) have a first electrode (3) and a second electrode (4) for receiving a potential difference, and an electrophoretic medium (5) which is present between the first electrode (3) and the second electrode (4). The medium (5) has a first and a second extreme optical state and an intermediate optical state, intermediate between the first and the second extreme optical state. For the display panel (1) to be able to display a reproducible intermediate optical state, the drive means (100) are able to control, in operation, the potential difference for changing the optical state between the first extreme, the second extreme and a singular equilibrium optical state as the intermediate optical state, in dependence of the picture element to be displayed.

The invention relates to an electrophoretic display panel, for displaying pictures comprising a plurality of picture elements, comprising:
a plurality of pixels for displaying the picture elements, each pixel comprising:
   a first electrode and a second electrode for receiving a potential difference; and
   an electrophoretic medium between the first electrode and the second electrode, which medium has a first and a second extreme optical state and an intermediate optical state intermediate between the first and the second extreme optical state; and
drive means able to control, in operation, the potential difference, having a pulse duration, for changing the optical state between the first extreme, the second extreme and the intermediate optical state, in dependence of the picture element to be displayed.

An embodiment of the electrophoretic display panel of the type mentioned in the opening paragraph is described in non-published European Patent application 02075846.2 (PHNL 020156).

In the described electrophoretic display panel each pixel represents one picture element. The optical state of the pixel equals the optical state of the represented picture element. The electrophoretic medium of the pixel includes positively and negatively charged particles in a transparent liquid. The positively charged particles have a color different from the negatively charged particles. In operation, the potential difference, controlled by the drive means, determines the motion of the charged particles. If the positively charged particles are positioned at the first electrode and the negatively charged particles are positioned at the second electrode, the medium is in the first extreme optical state. At the side of the first electrode, the picture element has the color of the positively charged particles. At an opposite potential difference the charged particles are at opposite positions and the medium is in the second extreme optical state. At the side of the first electrode, the picture element has the color of the negatively charged particles. To change the optical state of the medium from the first extreme optical state into the second extreme optical state and vice versa, the potential difference is relatively large and the pulse duration is relatively long. The optical state reached is insensitive to an overshoot in the potential difference and/or the pulse duration as a larger potential difference and/or a longer pulse duration has no further effect on the optical state. The display panel is able to display intermediate optical states, referred to as gray values. Gray value is herein understood to mean a color value in between the color of the first and the second extreme optical state. If the first and the second optical state represent white and black, the gray value represents a shade of gray; if the first and second optical state represent two other colors, the gray value stands for a mixed color of these two colors. In operation, to display the gray value the potential difference is pulsed, controlled by the drive means, wherein the pulse duration, the potential difference and many factors, that are difficult to control, determine the gray value. If, for instance, the viscosity or the dielectric constant of the liquid and/or particles changes due to e.g. a temperature variation, the motion of the charged particles is modified and the same pulse duration and the same potential difference results in a different gray value. Therefore, it is difficult to display a gray value in a reproducible manner.

It is a drawback of the described display panel that it is difficult to obtain therewith a reproducible gray value in the displayed picture.

It is an object of the invention to provide a display panel of the kind mentioned in the opening paragraph which is able to display, in operation, a reproducible gray value.

The object is thereby achieved that the drive means are able to control a singular equilibrium optical state as the intermediate optical state.

The invention is based on the insight that if the drive means are able to control the gray value representing an equilibrium optical state as the intermediate state to obtain the gray value thereof, the dependency of the relationship between this gray value and the many factors that are difficult to control is reduced. For instance, the temperature dependency depends on rheological properties of the particles within the liquid; such temperature dependency is much smaller, since the rheological properties are much less important. It has been observed that the electrophoretic medium reaches the same gray value, the gray value of 30 the equilibrium optical state, if the potential difference is substantially zero. Therefore, the display panel is able to display, in operation, a reproducible gray value.

The time interval to reach the equilibrium gray value is, for instance, tens of seconds to tens of minutes. The displayed picture is changed faster, if the drive means are able to control the potential difference:
of equal sign and a relative short pulse duration for changing the optical state from the first optical state to the equilibrium optical state, as compared to the potential difference and the pulse duration for changing the optical state from the first to the second optical state, and
of equal sign and a relative short pulse duration for changing the optical state from the second optical state to the equilibrium optical state, as compared to the potential difference and the pulse duration for changing the optical state from the second to the first optical state, and
subsequently being substantially zero.
   The potential difference having equal sign and relative short pulse duration brings the gray value near the equilibrium gray value. Subsequently, the potential difference is substantially zero and the electrophoretic medium reaches the equilibrium gray value.

The gray value depends on the number and the size of the colored particles. The displayed picture has a relatively good picture quality, if the equilibrium optical state is in the middle of the first and the second extreme optical state. Then the gray value is mid gray. In practice, the equilibrium optical state represents about mid gray, if for instance the number and the size of the positively charged particles is close to the number and the size of the negatively charged particles.

If each picture element is represented by one pixel, each picture element is able to have three optical states. However, if the drive means are able to represent each picture element by at least two neighboring pixels, each picture element is able to have more than three optical states, because of the optical states that are formed by combinations of optical states of the at least two neighboring pixels. If, furthermore, the equilibrium optical states are in the middle of the first and the second extreme optical states, the displayed picture has an even better picture quality. If, furthermore, the at least two neighboring pixels each have a surface with an area for displaying the optical state, a first area of the areas being substantially ⅓ of a second area of the areas, the picture element has at least nine, substantially uniformly distributed, optical states, between the two extreme optical states.

These and other aspects of the invention will be further elucidated and described with reference to the drawings, in which:

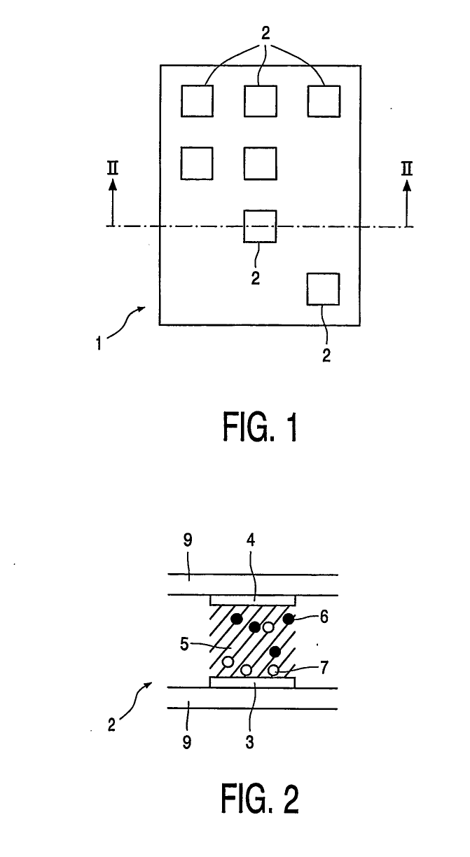

FIG. 1 shows diagrammatically a front view of the display panel,

FIG. 2 shows diagrammatically a cross-sectional view along II-II in FIG. 1,

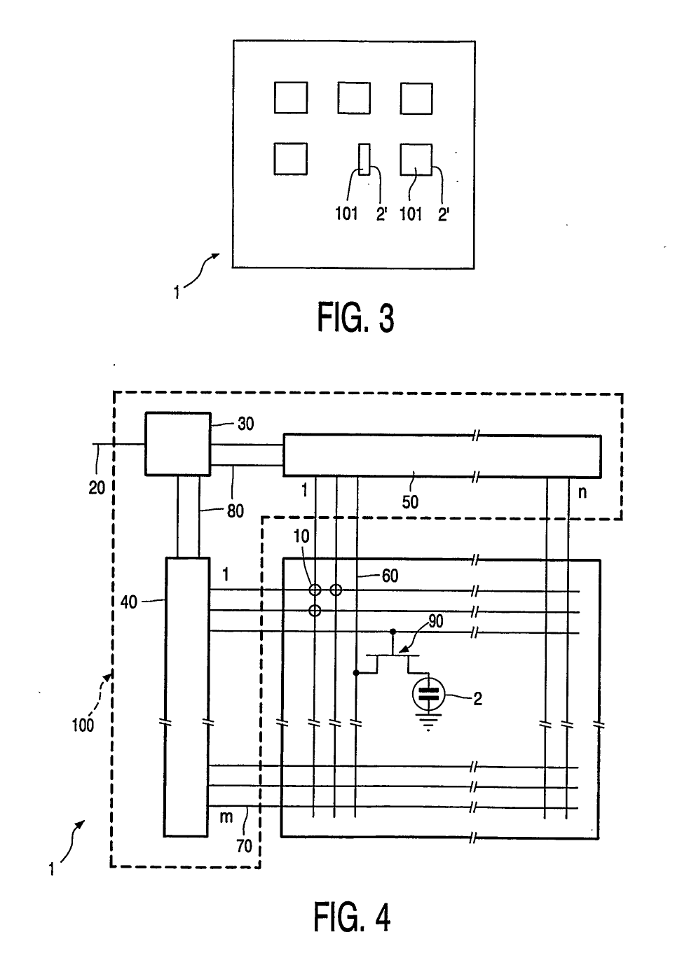

FIG. 3 shows diagrammatically a front view of the display panel, and

FIG. 4 shows diagrammatically an equivalent circuit diagram of a portion of the display panel.

The Figures are schematic and not drawn to scale and in all the figures same reference numerals refer to corresponding parts.

In FIG. 1 the display panel 1 has pixels 2. The pixels 2 are for instance arranged along substantially straight lines in a two-dimensional structure. For instance, one pixel represents one picture element.

In FIG. 2 the pixel 2 has a first electrode 3 and a second electrode 4, present on substrates 9, for receiving a potential difference. Furthermore, an electrophoretic medium 5 is present between the first electrode 3 and the second electrode 4, for instance positively charged black particles 6 and negatively charged white particles 7 in a transparent liquid. If the positively charged particles 6 are positioned at the first electrode 3 and the negatively charged particles 7 are positioned at the second electrode 4, the electrophoretic medium 5 is in the first extreme optical state. The potential difference is for instance −5 Volts. If the picture element is viewed from the side of the first electrode 3, the first electrode 3 being transparent, the picture element is black. In a reversal position of the charged particles 6,7, the electrophoretic medium 5 is in the second extreme optical state, and the picture element, viewed from the side of the first electrode 3, is white. Then the potential difference is for instance 5 Volts. To change the optical state of the electrophoretic medium 5 into one of the extreme optical states, the drive means are able to apply e.g. a potential difference of −5 Volts applied for a period of 5 seconds to change the optical state into the first extreme optical state and a potential difference of 5 Volts applied for a period of 5 seconds to change the optical state into the second extreme optical state.

If the electrophoretic medium 5 is in one of the extreme optical states and the potential difference is changed by the drive means to 0 Volts, the optical state changes slowly towards the equilibrium optical state, intermediate the extreme optical states, in the example the gray value. The interval to reach the intermediate optical state is adjustable, typically varying from tens of seconds to tens of minutes. This interval is shorter, for instance 2 seconds, if a potential difference of,

5 Volts is applied for 1 second for changing the optical state from the first optical state to the equilibrium optical state, and

−5 Volts is applied for 1 second for changing the optical state from the second optical state to the equilibrium optical state, and, subsequently, the potential difference is substantially zero. Then the electrophoretic medium reaches the equilibrium gray value.

If the number and sizes of the positively and the negatively charged particles 6,7 are equal, the equilibrium optical state represents mid gray and the displayed picture has a relatively good picture quality. If the size of the positively charged particles 6 is larger than the size of the negatively charged particles 7 the equilibrium optical state represents a color nearer to the color of the positively charged particles 6 than to the color of the negatively charged particles 7.

In FIG. 3 the two neighboring pixels 2′ representing a picture element are indicated. The optical state of each of the neighboring pixels 2′ is defined as 0, being the first extreme optical state, 1, being the equilibrium optical state, and 2, being the second extreme optical state. Then the picture element has nine optical states:
00: both neighboring pixels 2′ in optical state 0,
01: the first neighboring pixel 2′ in optical state 0 and the second neighboring pixel 2′ in optical state 1,
02, 10, 11, 12, 20, 21, and 22.
   As an example, the two neighboring pixels 2′ each have their equilibrium optical state in the middle of the first and the second extreme optical state. Furthermore, the area for displaying the optical state of the first neighboring pixel 2′ is substantially three times the area for displaying the optical state of the second neighboring pixel 2′. The represented picture element has nine, substantially uniformly distributed, optical states, between the two extreme optical states. For three neighboring pixels representing the picture element, the area for displaying the optical state of the first neighboring pixel being about three times the area for displaying the optical state of the second neighboring pixel and the area for displaying the optical state of the second neighboring pixel being about three times the area for displaying the optical state of the third neighboring pixel, the picture element has 27, substantially uniformly distributed, optical states, between the two extreme optical states, etc.

An electric equivalent, shown diagrammatically in FIG. 4, of a portion of the display panel 1 to which the invention is applicable, comprises drive means 100 and a matrix of pixels 2 at the area of crossings of row or selection electrodes 70 and column or data electrodes 60. The row electrodes 70 numbered from 1 to m in FIG. 4 are consecutively selected by means of a row driver 40, while the column electrodes 60 numbered from 1 to n in FIG. 4 are provided with data via a data register 50. If necessary, data to be displayed 20 is first processed in a processor 30. Mutual synchronization between the row driver 40 and the data register 50 takes place via drive lines 80 connected to the processor 30. The drive means 100 comprise, for example, the row driver 40, the row electrodes 70, the data register 50, the column electrodes 60, the drive lines 80 and the processor 30.

Drive signals from the row driver 40 and the data register 50 select a pixel 2, referred to as passive drive. A column electrode 60 receives such a potential with respect to a row electrode 70 that the pixel 2 obtains one of the extreme optical states or the equilibrium optical state at the area of the crossing, for example, black, white or mid gray. Drive signals from the row driver 40 select the pixels 2 via thin-film transistors, denoted as TFTs, 90 whose gate electrodes are electrically connected to the row electrodes 70 and whose source electrodes are electrically connected to the column electrodes 60, referred to as active drive. The signal present at the column electrode 60 is transferred via the TFT 90 to the pixel 2. In the example of FIG. 4, such a TFT 90 is shown diagrammatically for only one pixel 2.

It will be apparent that within the scope of the invention many variations are possible for a person skilled in the art.

The scope of the invention is not limited to the exemplary embodiments described herein. The invention is embodied in every novel feature and every combination of features.

1. An electrophoretic display panel, for displaying pictures comprising a plurality of picture elements, comprising:
a plurality of pixels for displaying the picture elements, each pixel comprising:
a first electrode and a second electrode for receiving a potential difference; and
an electrophoretic medium between the first electrode and the second electrode, which medium has a first and a second extreme optical state and an intermediate optical state intermediate between the first and the second extreme optical state; and
drive means able to control, in operation, the potential difference, having a pulse duration, for changing the optical state between the first extreme, the second extreme and the intermediate optical state, in dependence of the picture element to be displayed,
characterized in that the drive means are able to control a singular equilibrium optical state as the intermediate optical state.

2. An electrophoretic display panel as claimed in claimed 1 characterized in that the drive means are able to control the potential difference:
of equal sign and a relative short pulse duration for changing the optical state from the first optical state to the equilibrium optical state, as compared to the potential difference and the pulse duration for changing the optical state from the first to the second optical state, and
of equal sign and a relative short pulse duration for changing the optical state from the second optical state to the equilibrium optical state, as compared to the potential difference and the pulse duration for changing the optical state from the second to the first optical state, and
subsequently being substantially zero.

3. An electrophoretic display panel as claimed in claimed 1 characterized in that the equilibrium optical state is in the middle of the first and the second extreme optical state.

4. An electrophoretic display panel as claimed in claim 1 characterized in that the drive means are able to represent each picture element by at least two neighboring pixels.

5. An electrophoretic display panel as claimed in claimed 4 characterized in that the at least two neighboring pixels each have a surface with an area for displaying the optical state, a first area of the areas being substantially ⅓ of a second area of the areas.
